(19) United States
(12) Patent Application Publication
(10) Pub. No.: US 2007/0023504 A1
(43) Pub. Date: Feb. 1, 2007

(54) Computer implemented flexible benefit plan host based stored value card product

(75) Inventors: Barry J. Blankenship, Katy, TX (US); Keith W. Fulton, Tulsa, OK (US); Milton C. Li, Houston, TX (US); Quynh Dinh Pham, Houston, TX (US)

Correspondence Address: BRACEWELL & GIULIANI LLP, P.O. BOX 61389, HOUSTON, TX, 77208-1389, US

(73) Assignee: F.S.V. Payment Systems, Inc.

(21) Appl. No.: 11/437,052

(22) Filed: May 19, 2006

Related U.S. Application Data
(60) Provisional application No. 60/682,506, filed on May 19, 2005.

(51) Int. Cl. G06K 5/00; G06Q 40/00

(52) U.S. Cl. 235/380; 705/44

(57) ABSTRACT

A system, method, computer program and product to allow a card processor to use a single card with a card account number for payment from different account fund buckets. The first account fund bucket is an unrestricted general account fund bucket with funds available to make purchases of goods and services. The second account fund bucket is a restricted account fund bucket that can be used for the purchase of third party administrator approved goods and services. The card processor determines if a transaction is for third party administrator approved goods and services. If the requested transaction is for approved goods and services, the card processor deducts the costs of the approved goods and services first from the second restricted account fund bucket, and then from the first unrestricted account fund bucket. If sufficient funds are not available in the multiple account buckets, the card processor denies the requested transaction.

### 1. CROSS-REFERENCE TO RELATED APPLICATION

This application claims priority to provisional patent application 60/682,506 filed May 19, 2005.

### 2. FIELD OF THE INVENTION

The present invention relates to financial cards and financial card transactions, information exchange and information based processing and, more particularly, to stored value card systems, methods and products for using a single card to access funds or account information from multiple accounts over a financial network.

### 3. DESCRIPTION OF THE RELATED ART

The use of a card to access a financial account for transactions has been well known and well used in the field of payment systems. Most people today have been familiar to some extent with credit cards, debit cards, ATM cards, pre-paid cards, and/or stored value cards. These cards have allowed the user of the card to complete payment from the account associated with the card for transactions of goods and services. These transactions have occurred at a number of locations including but not limited to retail establishments, banks, websites on the Internet, and/or at service providers such as, in the medical service context, hospitals or doctors' offices. Furthermore, these transactions usually have occurred at some form of point-of-sale device (POS) that includes, for example, dedicated POS hardware, integrated cash registers, computer terminals, and handheld computing devices.

Additionally, most users of cards today have been for some time at least familiar with making a purchase using either a credit card or a debit card. Examples of credit cards include those offered under the trademarks Visa®, MasterCard®, American Express®, Diners Club®, and Discover®, as well as dedicated credit cards for gas stations, telephone companies, or department stores. Credit card transactions have involved the user presenting the card for payment, and some form of approval by the issuing entity of the credit card. The user typically has been required to sign the receipt for the credit card transaction, and the user has been billed at a later date for payment of outstanding debt on the credit card account. Credit cards today, so far as known, have been associated with only one account per card. Credit card transactions have been approved and settled over a financial network associated with the issuer of the card, e.g., Visa® or MasterCard®. These financial networks have multiple ways of transmitting and approving a credit card transaction.

Debit cards in contrast to credit cards have deducted money from an account at the time of purchase, typically a demand deposit account (DDA) held by a financial institution. Two common types of debit cards that have been known in the art are personal identification number (PIN) based debit cards, and signature based debit cards. A PIN based debit card transaction has involved the user presenting the card for payment, and entering the PIN directly or indirectly into the POS to authorize the transaction. PIN based debit card transactions have been approved and settled over various financial networks that have typically been referred to as regional debit card networks, e.g., Pulse®, Star®, Cirrus®, or Maestro®. Although debit cards have been associated with multiple accounts at a bank for one account holder, and may include checking accounts, savings accounts, or money market accounts, at a standard POS debit transaction only the primary account for the card, typically the checking account has been accessed for payment. Additionally, it has been known in the art to use pre-established commands to withdraw funds from a related account if the primary account has had insufficient funds, e.g., account overdraft protection.

Signature based debit cards have functioned similarly to PIN based debit cards in that they access funds in an existing account near the time of purchase. Furthermore, signature based debit cards may be used with a PIN in the same fashion as a PIN based debit card at an ATM or at a POS that accepts PIN based debit card transactions. Because signature based debit cards typically have been branded, approved, and settled under a financial network such as those mentioned previously, signature based debit cards have been used in a similar fashion to credit cards, and presented as payment for goods and services where credit cards transactions are accepted and PIN based debit card transactions are not accepted, e.g., at restaurants, doctors offices, internet transactions, and/or telephone transactions.

In addition to credit and debit cards, there have been various cards that are generally referred to as stored value cards, which may be anonymous. Examples of anonymous stored value cards have included prepaid telephone cards, gift certificate cards, and prepaid cash substitute cards. These cards are paid for in advance, and then later used in exchange for goods and services at a specific retailer, service provider, or within a specified financial network, such as the types previously mentioned. These cards have functioned similar to credit or debit cards depending on the issuer and/or processor of the card.

Another type of stored value card that has been known is a stored value card that is not anonymous. An example of this type of stored value card has been a payroll card, where a third party processor maintains a pool of accounts for different identified individuals, and the processor maintains one or more accounts at a financial institution that holds the pool of funds for the users. From the user's perspective, the user's account in the pooled account has functioned similar to a DDA at a financial institution, and has been accessed depending on the card as either a PIN or signature based debit card. Although payroll cards have been used as an example of an identified individual stored value card, other forms of user identified stored value cards exist in the art.

Additionally, the art has been familiar with third party administrator benefit plan cards associated with Cafeteria Style Section 125 Plans, which have allowed an account holder to use pre-tax dollars set aside from their paycheck for health costs during a given period of time. These benefit accounts have included Medical Expense Flexible Spending Accounts (FSA); Dependant Care Flexible Spending Accounts (DFSA); Health Reimbursement Accounts (HRA); Qualified Transportation Benefit Reimbursement Accounts (QTBRA); Health Savings Accounts (HSA); or other types of federal approved accounts under the Internal Revenue Code.

The art has been familiar with using transaction information or data transmitted from a POS that identifies either the type of merchant or the type of goods and services being purchased. Based on this information it has been possible to determine where or what goods and services have been purchased. Furthermore, this information has been used to determine if these goods and services qualify under an approved third party administrator benefit plan. If the goods and services qualify, the funds in an approved third party administrator benefit plan have been applied against the cost of the purchase.

In addition to credit cards, debit cards, and stored value cards it has not been unknown in the art to have one card that can perform various functions as disclosed in U.S. Pat. Nos. 6,000,608 and 6,189,787 by Robert Dorf., e.g., pre-paid gift certificate card, pre-paid phone card, loyalty card.

### SUMMARY OF INVENTION

Briefly, the present invention provides a card and a financial card system used therewith permitting a client or user with a single card to access multiple financial accounts for the payment of goods and services. Unlike the standard credit card, which can access one account, or debit card, which can access various accounts of an account holder at one financial institution, an account holder is with the present invention able to access various account fund buckets controlled by various entities or account holders with one card. An account fund bucket according to the present invention is an amount of funds electronically associated with an account that are segregated and separately accessible from other fund accounts for use. The funds in a particular fund bucket may be expressly limited for use for particular types of transactions or purchases according to the system design. Another type of fund bucket may be a general account without restrictions on the types of purchases or transactions that the funds may be used. More specifically, with the present invention, an account holder is able to use one card to access multiple account fund buckets, including at least one general account fund bucket for unrestricted spending, and an account fund bucket associated Cafeteria Style Section 125 Plans for restricted spending of third party administrator benefit plan pre-approved goods and services.

The present invention thus provides a financial card system, where a card processor manages multiple account fund buckets including a third party administrator benefit plan account fund bucket. The system of the present invention utilizes a financial card that has at least one unrestricted general account fund bucket with an associated amount of funds for the unrestricted purchase of goods and services. The financial card also has at least a second account fund bucket with an associated amount of funds for the restricted purchase of third party administrator benefit plan approved goods and services. The third party administrator benefit plan may be an FSA, DFSA, HRA, QTBRA, HSA, or other types of federal approved accounts under the Internal Revenue Code.

When the financial card is being used for the purchase of goods and services, the card processor first determines if the goods and services sought to be purchased are third party administrator benefit plan approved goods and services. If the goods and services sought are third party administrator benefit plan approved goods and services, then the card processor determines if sufficient funds are available in the restricted account fund bucket. If sufficient funds are available in the restricted account fund bucket, then the card process deducts the cost of the goods and services from the amount of funds in the restricted account fund bucket.

If the goods and services sought are third party administrator benefit plan approved goods and services and sufficient funds are not available in the restricted account fund bucket, the card processor determines if partial funds are available in the restricted account fund bucket to cover part of the cost of the purchase of the third party administrator benefit plan approved goods and services. If partial funds are available in the restricted account fund bucket, the card processor then determines if sufficient funds are available in the unrestricted account fund bucket for the balance of the cost of the third party administrator benefit plan approved goods and services. If sufficient funds are available in the unrestricted account fund bucket for the balance of the cost of the third party administrator benefit plan approved goods and services, then the card processor first deducts the partial amount of funds from the restricted account fund bucket, and then deducts the balance of cost from the unrestricted account fund bucket.

If the goods and services sought to be purchased are not third party administrator benefit plan approved goods and services, then the card processor determines if sufficient funds are available in the unrestricted account fund bucket. If sufficient funds are available in the unrestricted account fund bucket for the cost of goods and services sought, then the card processor deducts the amount of funds from the unrestricted account fund bucket.

In either event, if sufficient funds are not available in the restricted account fund bucket and the unrestricted account fund bucket, then the card processor denies approval of the requested purchase of goods and services.

The different fund buckets can have different limitations placed on the account fund buckets that limit the rate at which funds can be spent from a given fund bucket. These limitations can be different for different cards processed by the system.

The card processor is connected to a POS device by a financial network that can use credit card networks, regional debit networks, or other networks used to transmit financial data for the routing of transaction information. If a credit card network is used, the financial card that is part of the system may bear the logo of the credit network being used, such as the types previously mentioned. Similarly, if a regional debit network is used for routing transaction information, the card may bear the logo of one or more regional debit networks, such as the types previously mentioned.

Additionally, the card used according to the present invention may bear a logo or identify a pharmacy benefit member, a corporate sponsor, an employer of the cardholder of the financial card used by this system, or some other participating organization.

The financial card system of the present invention may also use other account fund buckets including for example an overdraft protection fund bucket that allows a card used in the system to exceed the amount of funds available in the restricted and unrestricted fund buckets discussed above.

The financial card system of the present invention may also access information associated with an account such as insurance that may be available, e.g., health insurance. When the card is presented as payment for goods and services, such as a doctor's office, the financial card system interacts with an insurance provider to determine the amount of payment owed by the account based on the insurance policy information associated with the financial card. The financial card system then determines if funds are available and from which account to deduct funds, and communicate any necessary information to the insurance provider and/or goods and services provider.

The present invention also provides a method where a card processor processes transactions for a financial card having an unrestricted general account fund bucket with an associated amount of funds for the unrestricted purchase of goods and services. The financial card also has a second restricted account fund bucket with an associated amount of funds for the restricted purchase of a third party administrator benefit plan approved goods and services. When the financial card is presented as payment for goods and services, the card processor first determines if the goods and services sought are third party administrator benefit plan approved goods and services. The third party administrator benefit plan may be an FSA, DFSA, HRA, QTBRA, HSA, or other types of federal approved accounts under the Internal Revenue Code.

If the goods and services sought are third party administrator benefit plan approved goods and services, then the card processor determines if sufficient funds are available in the restricted account fund bucket. If sufficient funds are available in the second restricted account, the card processor deducts the cost of the goods and services from the amount of funds in the restricted account fund bucket. If sufficient funds are not available in the restricted account fund bucket, the card processor determines if partial funds are available in the restricted account fund bucket to cover a portion of the costs of the purchase of the third party administrator benefit plan approved goods and services. If partial funds are available in the restricted account fund bucket, the card processor then determines if sufficient funds are available in the unrestricted account fund bucket for the balance of the cost of third party administrator benefit plan approved goods and services. If sufficient funds are available in the unrestricted account fund bucket to cover the balance of the cost of third party administrator benefit plan approved goods and services, then the card processor first deducts the partial amount of funds from the restricted account fund bucket, and then deducts the balance of the cost of the third party administrator approved benefit plan goods and services from the funds in the unrestricted account fund bucket.

If the goods and services sought to be purchased are not third party administrator benefit plan approved goods and services, then the card processor determines if sufficient funds are available in the unrestricted account fund bucket. If sufficient funds are available in the unrestricted account fund bucket for the cost of the goods and services sought, then the card processor deducts the cost from the amount of funds in the unrestricted account fund bucket.

If sufficient funds are not available in the restricted account fund bucket nor the unrestricted account fund bucket, then the card processor denies approval of the requested purchase of goods and services.

The different fund buckets can have different limitations placed on the account fund buckets that limit the rate at which funds can be spent from a given fund bucket. These limitations can be different for different cards processed using this method.

The card processor with the present invention is connected to a POS device by a financial network that can uses credit card networks, regional debit networks, or other networks used to transmit financial data for the routing of transaction information. If a credit card network is used, the financial card that is used by this method may bear the logo of the credit network being used, such as the types previously mentioned. Similarly, if a regional debit network is used for routing transaction information, the card that is used by this method may bear the logo of one or more regional debit networks, such as the types previously mentioned.

The method according to the present invention may also use other account fund buckets including for example an overdraft protection fund bucket that allows a card to exceed the amount of funds available in the restricted and unrestricted fund buckets discussed above.

The method according to the present invention may also access information associated with an account such as insurance that may be available, e.g., health insurance. When the card is presented as payment for goods and services, such as a doctor's office, determining the amount of payment owed by the account based on the insurance policy information associated with the financial card. The method then determines if funds are available and from which account to deduct funds, and communicates any necessary information to the insurance provider and/or goods and services provider.

The present invention further provides a computer program product for processing transactions for a financial card presented for payment of a purchase of goods and services where the financial card has two or more fund buckets. The first fund bucket is an unrestricted general account fund bucket with an associated amount of funds for the unrestricted purchase of goods and services. The financial card also has a second restricted account fund bucket with an associated amount of funds for the restricted purchase of a third party administrator benefit plan approved goods and services. When the financial card is presented as payment for goods and services, a computer program is used that first determines if the goods and services sought are third party administrator benefit plan approved goods and services. The third party administrator benefit plan may be an FSA, DFSA, HRA, QTBRA, HSA, or other types of federal approved accounts under the Internal Revenue Code.

If the goods and services sought are third party administrator benefit plan approved goods and services, then the computer program product causes the card processor to determine if sufficient funds are available in the restricted account fund bucket. If sufficient funds are available in the second restricted account, the computer program product causes the card processor to deduct the cost of the goods and services from the amount of funds in the restricted account fund bucket. If sufficient funds are not available in the restricted account fund bucket, the computer program product causes the card processor to determine if partial funds are available in the restricted account fund bucket to cover a portion of the costs of the purchase of the third party administrator benefit plan approved goods and services. If partial funds are available in the restricted account fund bucket, the computer program product causes the card processor to then determine if sufficient funds are available in the unrestricted account fund bucket for the balance of the cost of third party administrator benefit plan approved goods and services. If sufficient funds are available in the unrestricted account fund bucket to cover the balance of the cost of third party administrator benefit plan approved goods and services, then the computer program product causes the card processor to first deduct the partial amount of funds from the restricted account fund bucket, and then deduct the balance of the cost of the third party administrator approved benefit plan goods and services from the funds in the unrestricted account fund bucket.

If the goods and services sought to be purchased are not third party administrator benefit plan approved goods and services, then the computer program product causes the card processor to determine if sufficient funds are available in the unrestricted account fund bucket. If sufficient funds are available in the unrestricted account fund bucket for the cost of the goods and services sought, then the computer program product causes the card processor to deduct the cost from the amount of funds in the unrestricted account fund bucket.

If sufficient funds are not available in the restricted account fund bucket nor the unrestricted account fund bucket, then the computer program product causes the card processor to deny approval of the requested purchase of goods and services.

The different fund buckets can have different limitations placed on the account fund buckets that limit the rate at which funds can be spent from a given fund bucket. These limitations can be different for different cards processed using this computer program.

The card processor is connected to a POS device by a financial network that can uses credit card networks, regional debit networks, or other networks used to transmit financial data for the routing of transaction information. If a credit card network is used, the financial card that is used by this method may bear the logo of the credit network being used, such as the types previously mentioned. Similarly, if a regional debit network is used for routing transaction information, the card that is used by this method may bear the logo of one or more regional debit networks, such as the types previously mentioned.

The computer program product according to the present invention may also use other account fund buckets including for example an overdraft protection fund bucket that allows a card used in the system to exceed the amount of funds available in the restricted and unrestricted fund buckets discussed above.

The computer program product according to the present invention may also access information associated with an account such as insurance that may be available, e.g., health insurance. When the card is presented as payment for goods and services, such as a doctor's office, the computer program interacts with a health insurance provider to determine the amount of payment owed by the account based on the insurance policy information associated with the financial card. The computer program then determines if funds are available and from which account to deduct funds, and communicate any necessary information to the insurance provider and/or goods and services provider.

The present invention further relates to a financial card that has a card account number, and data storage areas or indicia relating to at least two account fund buckets. The card has data storage for data regarding a first account fund bucket having funds available for unrestricted purchase of goods and services. The card has data storage for data regarding a second account fund bucket having funds available for restricted purchases of goods and services for third party administrator benefit plan approved goods and services.

The different fund buckets indicated by data storage areas of the financial card can have different limitations placed on the account fund buckets that limit the rate at which funds can be spent from a given fund bucket. Furthermore, these limitations can be different for different cards.

The financial card of the present invention is capable of being used with credit card networks, regional debit networks, or other networks used to transmit financial data for the routing of transaction information. If a credit card network is used, the financial card may bear the logo of the credit network being used, such as the examples listed above. Similarly, if a regional debit network is used the card may bear the logo of one or more regional debit networks, such as the examples listed above. Additionally, the card may bear a logo or identify a pharmacy benefit member, a corporate sponsor, or an employer of the cardholder.

The financial card may also use other account fund buckets including for example an overdraft protection fund bucket that allows a card used in the system to exceed the amount of funds available in the restricted and unrestricted fund buckets discussed above.

The financial card may also be used access or provide information associated with an account such as insurance that may be available, e.g., health insurance.

In view of the foregoing, embodiments of systems, methods, and products according to the present invention beneficially provide enhanced features over the existing financial cards by allowing a single card to be associated with different account fund buckets based on the goods and services to be purchased.

### BRIEF DESCRIPTION OF THE DRAWINGS

The objects, advantages and features of the invention will become more apparent by reference to the drawings appended thereto, wherein like numerals indicate like parts and wherein an illustrated embodiment of the invention is shown, of which:

FIG. 1 is a front elevation view of a financial card according to the present invention.

FIG. 2 is a rear elevation view of the financial card of FIG. 1.

FIG. 3 is a schematic diagram of the various elements and their relation to each other for the purchase of goods and services according to the present invention.

FIG. 4 is a flowchart block diagram of the steps performed by the card processor in a preferred embodiment of the present invention.

FIG. 5 is a flowchart block diagram of the steps performed by a card processor in an alternate embodiment of the present invention.

### DETAILED DESCRIPTION OF THE INVENTION

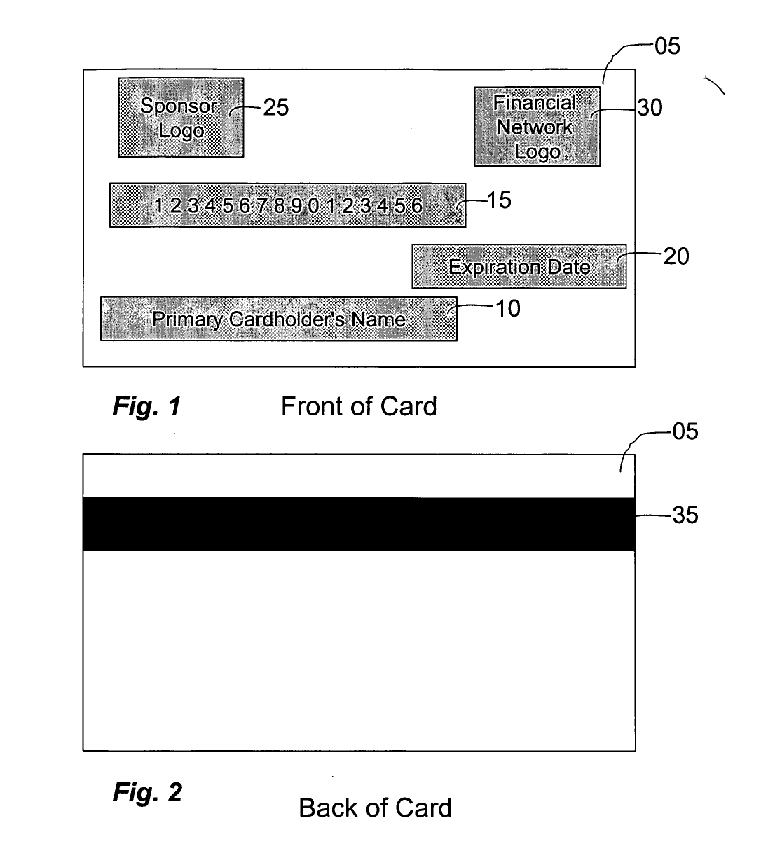

Referring to FIG. 1 and FIG. 2, a financial card 5 according to the present invention is shown. The financial card 5, as will be described, is presented for payment at a retailer or service provider, such as a grocery store, pharmacy, a medical supply store, or a doctor's office. The card 5 has several pieces of information displayed on the front elevation of card 5, and may include the primary cardholder's name 10, the card account number 15, the expiration date 20, the sponsor logo 25, and the financial network logo 30.

In the preferred embodiment the card is branded with a financial network logo 30 such as Visa® or MasterCard® that allows for purchases at a Visa® or MasterCard® approved retailer. In an alternate embodiment the card may feature a pharmacy benefit member logo. In another alternate still, the card may have the logos of both the card sponsor 25 and pharmacy benefit member. In another alternate the card may have the logo of a corporate or retailer card sponsor 25, such as an employer. In another alternate still the card could include both logos of financial network logo 30 and the logo of a corporate or retailer sponsor.

The card 5, which in the preferred embodiment use a magnetic stripe 35 to encode account information as data for electronic reading by a POS device, contains data that associate the card 5 with a cardholder account. In alternate embodiments of the present invention, card 5 may be a smartcard, which is type of card that contains a microprocessor and/or memory chip in lieu of a magnetic stripe 35 to store and access cardholder account information. It is also possible for card 5 to use a bar code instead of a magnetic stripe 35 to encode information for accessing cardholder account information.

The magnetic stripe 35 shown in FIG. 2 on the rear elevation of the card 5 encodes various piece of data that associate card 5 with a particular cardholder account. This data includes the necessary information to route the transaction request over a financial network, and includes card account number 15 for the cardholder account.

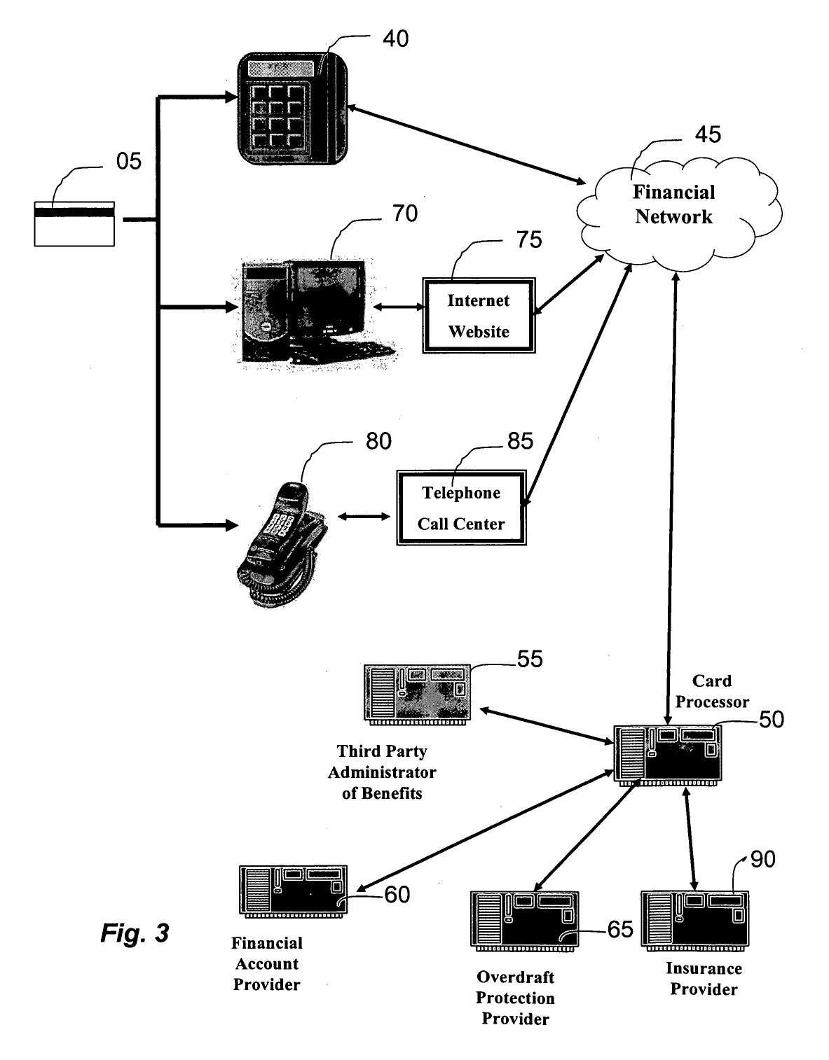

Referring to FIG. 3, when card 5 is presented for payment of goods and services at a retailer or service provider location, card account number 15 is entered into a POS device 40, which may be a dedicated piece of hardware, an integrated cash register, a computer terminal, or a handheld computing device. In the preferred embodiment, the account information is entered into the POS device 40 by either swiping the magnetic stripe 35 of card 5 through a magnetic stripe reader in the POS device 40 or by manual entry of card account number 15 into POS device 40. The POS device 40 then routes the data to a financial network 45 that transmits the data to card processor 50 that maintains cardholder account information associated with card account number 15 in one or more databases.

Card processor 50 is a computer and can be a mainframe computer of any conventional type of suitable processing capacity such as those available from International Business Machines (IBM) of Armonk, N.Y., Dell Computer of Austin, Tex., or other source. Other digital processors, however, may be used, such as a laptop computer, or any other suitable processing apparatus.

In any case, the computer processor of the card processor 50 accesses the information associated with a cardholder account to undertake the logic of the present invention, which may be executed by a computer processor as a series of computer-executable instructions. The instructions may be contained on a data storage device that is part of card processor 50 with a computer readable medium, such as a computer diskette having a computer usable medium stored thereon. Or, the instructions may be stored in memory of the card processor 50, or on magnetic tape, conventional hard disk drive, electronic read-only memory, optical storage device, or other appropriate data storage device.

Card processor 50 then communicates with third party administrator of benefits 55 or financial account provider 60 to debit the associated account value over a telephone line, dedicated connection, the Internet, computer network, cellular phone, satellite, cable, or any other available communication method.

The financial network 45 may be one of the various networks sponsored by a credit card company, such as the types previously mentioned. In an alternate embodiment, the financial network 45 may be sponsored by one of the various regional debit networks, such as the types previously mentioned.

In more detail, part of the data provided to card processor 50 from the financial network 45 and sent by POS device 40 in a transaction request is a merchant category code approved by the financial network 45. The merchant category code distinguishes between different types of retailers and service providers, e.g., grocery stores or doctor's office. Card processor 50 debits a specific card holder account fund bucket based on the transaction type disclosed by the merchant category code.

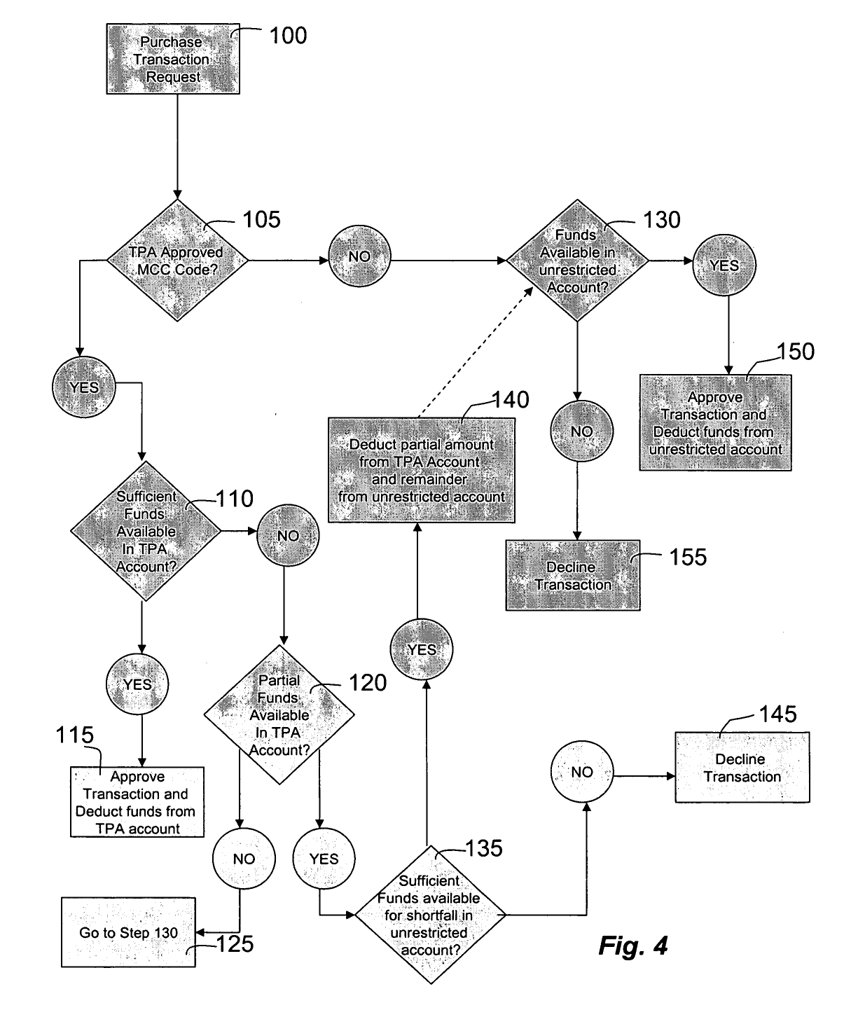

The flow chart of FIG. 4 herein illustrates the structure of the logic of the present invention as embodied in computer program software. Those skilled in the art will appreciate that the flow charts illustrate the structures of computer program code elements including logic circuits on an integrated circuit that function according to this invention. Manifestly, the invention is practiced in its essential embodiment by a machine component that renders the program code elements in a form that instructs a digital processing apparatus (that is, a computer) to perform a sequence of function steps corresponding to those shown.

It is important to note that, while the present invention has been, and will continue to be, described in the context of a fully functional computer system, those skilled in the art will appreciate that the present invention is capable of being distributed as a program product in a variety of forms, and that the present invention applies equally regardless of the particular type of signal-bearing media utilized to actually carry out the distribution. Examples of signal-bearing media include: recordable-type media, such as floppy disks, hard disk drives, and CD ROMs, and transmission-type media such as digital and analog communication links.

Card processor 50 determines in regards to a purchase transaction request 100 in step 105 whether the purchase transaction request 100 includes a third party administrator of benefits 55 approved merchant category code. If the merchant category code is a third party administrator of benefits 55 approved merchant category code, then card processor 50 in step 110 determines if sufficient funds are available in the third party administrator of benefits 55 account fund bucket based on third party administrator of benefits 55 criteria and account type, which may include but is not limited to an FSA, DFSA, HRA, QTBRA, HSA, or other types of federal approved benefit accounts under the Internal Revenue Code. If sufficient funds are available in the third party administrator of benefits 55 account fund bucket, card processor 50 approves the transaction in step 115 and deducts the corresponding amount from third party administrator of benefits 55 account fund bucket.

If sufficient funds are not available in third party administrator of benefits 55 account fund bucket, card processor 50 has to determine in step 120 if partial funds are available in third party administrator of benefits 55 account fund bucket for the cardholder's use as payment for third party administrator of benefits 55 approved goods and services.

If partial funds are not available, card processor 50 has to determine in step 125 whether or not funds are available in a related unrestricted cardholder account fund bucket according to the process beginning at step 130, as discussed below.

If card processor 50 determines in step 120 that partial funds are available, card processor 50 has to determine in step 135 if sufficient funds are available in a related unrestricted cardholder account fund bucket. If sufficient funds are available in a related unrestricted cardholder account fund bucket, card processor 50 deducts the partial funds amount from the third party administrator of benefits 55 account fund bucket, and proceeds to step 130 to deduct the remaining funds from the related unrestricted cardholder account fund bucket.

If sufficient funds are not available in cardholder's unrestricted account fund bucket, card processor 50 declines the transaction in step 145.

In step 130, card processor 50 determines if sufficient funds are available in a cardholder's unrestricted account fund bucket, and if funds are available card processor 50 approves the transaction in step 150. If sufficient funds are not available, card processor 50 declines the purchase transaction request 100 in step 155.

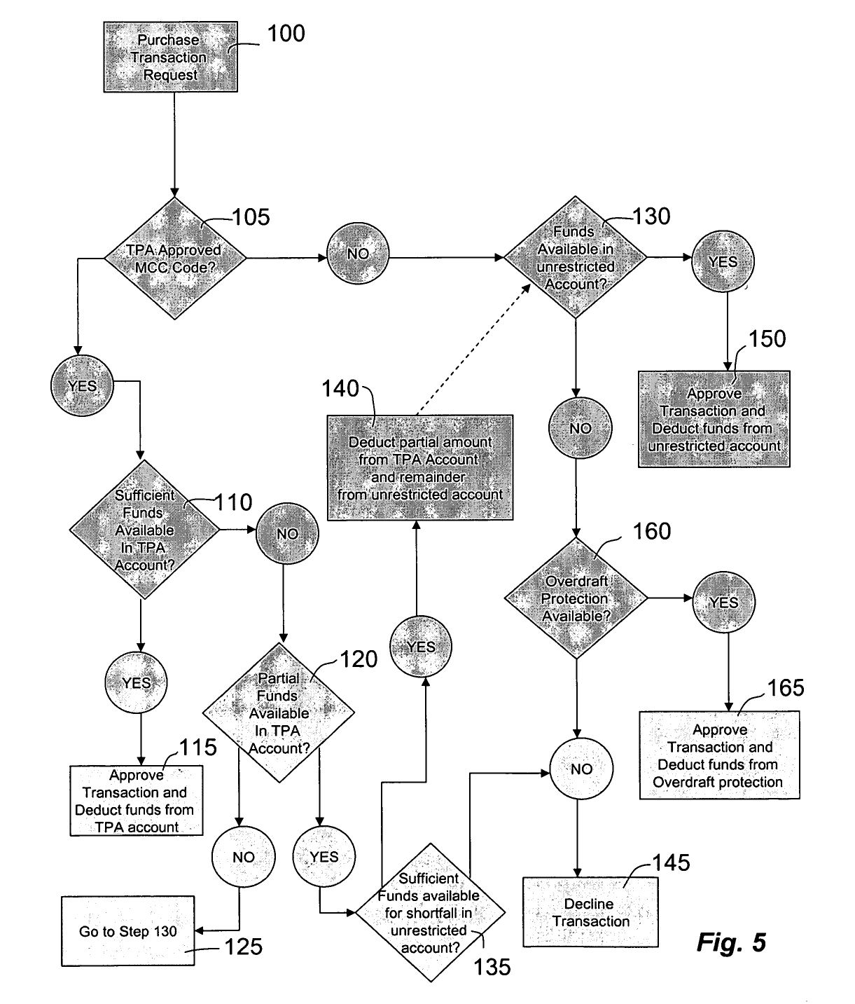

Referring to FIG. 5, in an alternate embodiment, card processor 50 communicates with overdraft protection provider 65 to provide overdraft protection if card 5 is used to make a purchase of goods or services with insufficient funds. As detailed in FIG. 5, if overdraft protection is available step 155 of FIG. 4 is replaced with step 160 of FIG. 5, and card processor 50 has to determine if the cardholder unrestricted account has overdraft protection in step 160. If the cardholder account has sufficient overdraft protection as determined by card processor 50 in step 160, card processor 50 approves the transaction. If there is not sufficient overdraft protection, card processor declines the transaction in step 145.

In another embodiment, card 5 can be used to make purchases of goods and services over the Internet. Using a computer 70 to access a website 75 of a goods or services provider located on the Internet, the cardholder completes the necessary transaction request on website 75, and proceeds to some payment function associated with website 75. The cardholder then enters the card account number 15 into the payment function webpage at website 75. Website 75 then connects to a financial network 45 to obtain authorization for the transaction. The financial network 45 then routes the transaction information to card processor 50.

Referring to FIG. 3, when the card account number 15 is entered into the payment function webpage of website 75, website 75 routes the necessary transaction information and card account number 15 to a financial network 45 that transmits the data to card processor 50 that maintains cardholder account information associated with card account number 15 in one or more databases. Card processor 50 then communicates with third party administrator of benefits 55 or financial account provider 60 to debit the associated account fund bucket.

As discussed above, in the data provided to card processor 50 in a transaction request includes a merchant category code approved by the financial network 45, and as discussed above this code distinguishes between different types of retailers and service providers. Card processor 50 then debits a specific card holder account fund bucket based on the transaction type disclosed by the merchant category code.

In another embodiment, card 5 of can be used to make purchases of goods and services over a telephone 80, which may include but is not limited to a landline telephone, a cellular phone, a mobile phone, or an Internet based phone. Using a telephone 80 to access a telephone call center 85 of a goods or services provider, the cardholder completes the necessary transaction request according to the requirements of the telephone service provider 85, and proceeds to some payment function associated with telephone service provider 85. The cardholder then enters the card account number 15 into the payment function of the telephone service provider 85, which may be manually or verbally entered.

The telephone service provider 85 then connects to a financial network 45 to obtain authorization for the transaction. The financial network 45 then routes the data to card processor 50.

Referring to FIG. 3, when the card account number 15 is entered into the payment portion of the telephone service provider 85, telephone service provider 85 routes the necessary transaction data and card account number 15 to a financial network 45 that transmits the data to card processor 50 that maintains cardholder account information associated with card account number 15 in one or more databases.

Card processor 50 then communicates with third party administrator of benefits 55 or financial account provider 60 to debit the associated account fund bucket.

As noted above, the data provided to card processor 50 in a transaction request includes a merchant category code approved by the financial network 45, and this code distinguishes between different types of retailers and service providers. Card processor 50 then debits a specific card holder account fund bucket based on the transaction type disclosed by the merchant category code.

In another embodiment, card processor 50 based on other criteria determined by card processor 50 or third party administrator of benefits 55 may allow a purchase if insufficient funds are currently available in the various fund buckets. An example of this scenario may include regular payments into a fund bucket and when a certain number of regular payments are expected card processor 50 may allow a negative balance that is paid back over a specified period of regular payments to be made to the fund bucket. Therefore the determination of whether or not there are sufficient funds in an account fund bucket for the purchase of goods and services may be based on factors other than funds currently available in account fund bucket.

In another embodiment, card processor 50 determines to approve a purchase transaction request 100 based on the product being from a third party administrator of benefits 55 approved list of products. If the product is from a third party administrator of benefits 55 approved list of products, a similar determination of funds availability as discussed above for merchant category code codes is applied based on the products purchased. In this embodiment approved third party administrator of benefits 55 products are paid for from funds available in third party administrator of benefits 55 account fund bucket, and unapproved products are paid for based on funds availability in a card holder's unrestricted account fund bucket.

In another embodiment, card 5 could be associated with a health insurance policy of health insurance provider 90. Referring to FIG. 3, when card 5 is presented for payment of goods and services at a retailer or service provider location, for example a pharmacy or doctor's office, card account number 15 is entered into a POS device 40, such as those mentioned previously. The POS device 40 then routes the data to a financial network 45 that transmits the data to card processor 50 that maintains cardholder account information associated with card account number 15 in one or more databases.

In this embodiment, card processor 50 access information associated with card 5 related to available insurance coverage, such as health insurance, and communicates with an insurance provider 90 for the exchange of information associated with the card 5 and the insurance policy over a telephone line, dedicated connection, the Internet, computer network, cellular phone, satellite, cable, or any other available communication method.

Card processor 50 can then make determinations about goods and services covered by the insurance policy and deduct funds from the appropriate restricted or unrestricted account fund bucket.

In the preferred embodiment the system includes at least one card 5 that has more than one fund bucket or account available for different types of purchases. One of the fund buckets is a general unrestricted account fund bucket such as a payroll account, a DDA, stored value account, a prepaid account or some other form of unrestricted fund bucket. The cardholder also has a second fund bucket that could be a FSA, DFSA, HRA, QTBRA, HAS, or other type of federal approved accounts under the Internal Revenue Code. The cardholder account may have multiple restricted and unrestricted fund buckets available to be accessed by card 5. The cardholder account may also have overdraft protection if insufficient funds are available in the restricted or unrestricted accounts fund bucket maintained by card processor 50.

In the operation of the present invention, card 5 permits its holder to access multiple financial accounts for the payment of goods and services. Unlike the standard credit card, which can access one account, or the standard debit card, which can access various accounts of an account holder at one financial institution, an account holder is with the present invention able to access various account fund buckets controlled by various entities or account holders with card 5. An account fund bucket according to the present invention is an amount of funds electronically associated with an account that are segregated and separately accessible from other fund accounts for use. The funds in a particular fund bucket may be expressly limited for use for particular types of transactions or purchases according to the system design. Another type of fund bucket may be a general account without restrictions on the types of purchases or transactions that the funds may be used. More specifically, with the present invention an account holder is able to use card 5 to access both a general account fund bucket for unrestricted spending, and an account fund bucket associated Cafeteria Style Section 125 Plans for restricted spending of third party administrator benefit plan pre-approved goods and services, such as the types previously mentioned.

The financial card system of the present invention with card processor 50 manages multiple account fund buckets including a third party administrator benefit 55 plan account fund bucket. The system utilizes card 5 that has at least one unrestricted general account fund bucket with an associated amount of funds for the unrestricted purchase of goods and services. Card 5 also has a second account fund bucket with an associated amount of funds for the restricted purchase of third party administrator benefit 55 plan approved goods and services. The third party administrator benefit 55 plan may be an FSA, DFSA, HRA, QTBRA, HSA, or other types of federal approved accounts under the Internal Revenue Code.

When card 5 is used for the purchase of goods and services, the card processor 50 determines in step 105 if the goods and services sought to be purchased are third party administrator benefit 55 plan approved goods and services. If the goods and services sought are third party administrator benefit 55 plan approved goods and services, then the card processor 50 determines in step 110 if sufficient funds are available in the restricted account fund bucket. If sufficient funds are available in the restricted account fund bucket, then the card processor 50 deducts the cost of the goods and services from the amount of funds in the restricted account fund bucket in step 115.

If the goods and services sought are third party administrator benefit 55 plan approved goods and services and sufficient funds are not available in the restricted account fund bucket, the card processor 50 determines in step 120 if partial funds are available in the restricted account fund bucket to cover part of the cost of the purchase of the third party administrator benefit 55 plan approved goods and services. If partial funds are available in the restricted account fund bucket, the card processor then determines in step 135 if sufficient funds are available in the unrestricted account fund bucket for the balance of the cost of the third party administrator benefit 55 plan approved goods and services. If sufficient funds are available in the unrestricted account fund bucket for the balance of the cost of the third party administrator benefit 55 plan approved goods and services, then the card processor 50 in step 140 first deducts the partial amount of funds from the restricted account fund bucket, and then deducts the balance of cost from the unrestricted account fund bucket.

If the goods and services sought to be purchased are not third party administrator benefit 55 plan approved goods and services, then the card processor 50 determines in step 130 if sufficient funds are available in the unrestricted account fund bucket. If sufficient funds are available in the unrestricted account fund bucket for the cost of goods and services sought, then the card processor 50 deducts the amount of funds from the unrestricted account fund bucket in step 150.

In either event, if sufficient funds are not available in the restricted account fund bucket and the unrestricted account fund bucket, then the card processor 50 denies approval of the requested purchase of goods and services in steps 145 and 155.

The different fund buckets can have different limitations placed on the account fund buckets that limit the rate at which funds can be spent from a given fund bucket. These limitations can be different for different cards 5 processed by the system.

The card processor 50 is connected to a POS device 40 by a financial network 45 that can use credit card networks, regional debit networks, or other networks used to transmit financial data for the routing of transaction information. If a credit card network is used, card 5 that is part of the system may bear the financial network logo 30 of the credit network being used, such as the types previously mentioned. Similarly, if a regional debit network is used for routing transaction information, card 5 may bear the financial network logo 30 of one or more regional debit networks, such as the types previously mentioned.

Additionally, card 5 used by the system of the present invention may bear a sponsor logo 25 or identify a pharmacy benefit member, a corporate sponsor, or an employer of the cardholder of card 5 used by this system.

The financial card system of the present invention may also use other account fund buckets including for example an overdraft protection fund bucket that allows a card used in the system to exceed the amount of funds available in the restricted and unrestricted fund buckets discussed above.

The financial card system may also access information associated with an account such as insurance that may be available, e.g., health insurance. When card 5 is presented as payment for goods and services, such as a doctor's office, the financial card system interacts with an insurance provider 90 to determine the amount of payment owed by the account based on the insurance policy information associated with card 5. The financial card system then determines if funds are available and from which account to deduct funds, and then communicate any necessary information to the insurance provider and/or goods and services provider based on insurance provider 90 insurance policy.

The present invention thus provides a method where card processor 50 processes transactions for card 5 having an unrestricted general account fund bucket with an associated amount of funds for the unrestricted purchase of goods and services. Card 5 also has a second restricted account fund bucket with an associated amount of funds for the restricted purchase of a third party administrator benefit 55 plan approved goods and services. When card 5 is presented as payment for goods and services, the computer program product first causes processor 50 to determine in step 105 if the goods and services sought are third party administrator benefit 55 plan approved goods and services. The third party administrator benefit 55 plan may be an FSA, DFSA, HRA, QTBRA, HSA, or other types of federal approved accounts under the Internal Revenue Code.

If the goods and services sought are third party administrator benefit 55 plan approved goods and services, then the computer program product causes processor 50 to determine in step 110 if sufficient funds are available in the restricted account fund bucket. If sufficient funds are available in the second restricted account, in step 115 the computer program product causes processor 50 to deduct the cost of the goods and services from the amount of funds in the restricted account fund bucket. If sufficient funds are not available in the restricted account fund bucket, in step 120 the computer program product causes processor 50 to determine if partial funds are available in the restricted account fund bucket to cover a portion of the costs of the purchase of the third party administrator benefit 55 plan approved goods and services. If sufficient funds are available in the unrestricted account fund bucket to cover the balance of the cost of third party administrator benefit 55 plan approved goods and services, then in step 140 the computer program product causes processor 50 to first deduct the partial amount of funds from the restricted account fund bucket, and then deduct the balance of the cost of the third party administrator approved benefit 55 plan goods and services from the funds in the unrestricted account fund bucket.

If the goods and services sought to be purchased are not third party administrator benefit 55 plan approved goods and services, then the card processor 50 determines in step 130 if sufficient funds are available in the unrestricted account fund bucket. If sufficient funds are available in the unrestricted account fund bucket for the cost of the goods and services sought, then in step 150 the card processor 50 deducts the cost from the amount of funds in the unrestricted account fund bucket.

If sufficient funds are not available in the restricted account fund bucket nor the unrestricted account fund bucket, then the card processor 50 denies approval of the requested purchase of goods and services in steps 145 and 155.

The different fund buckets used in the method of the present invention can have different limitations placed on the account fund buckets that limit the rate at which funds can be spent from a given fund bucket. These limitations can be different for different cards 5 processed using this method.

The card processor 50 of the present invention, being connected to a POS device 40 by a financial network 45, can use credit card networks, regional debit networks, or other networks used to transmit financial data for the routing of transaction information. If a credit card network is used, card 5 used with this method may bear the financial network logo 30 of the credit network being used, such as the types previously mentioned. Similarly, if a regional debit network is used for routing transaction information, card 5 that is used by this method may bear the financial network logo 30 of one or more regional debit networks, such as the types previously mentioned.

The method of the present invention herein described may also use other account fund buckets including for example an overdraft protection fund bucket that allows card 5 to exceed the amount of funds available in the restricted and unrestricted fund buckets discussed above.

The method of the present invention may also access information associated with an account such as insurance that may be available, e.g., health insurance. When card 5 is presented as payment for goods and services, such as a doctor's office, determining the amount of payment owed by the account based on the insurance policy information associated with card 5. The method then determines if funds are available and from which account to deduct funds, and communicates any necessary information to the insurance provider 90 and/or goods and services provider.

The present invention further provides a computer program product for processing transactions for card 5 presented as payment of a purchase of goods and services where the financial card has two or more fund buckets. The first fund bucket is an unrestricted general account fund bucket with an associated amount of funds for the unrestricted purchase of goods and services. Card 5 also has a second restricted account fund bucket with an associated amount of funds for the restricted purchase of a third party administrator benefit plan approved goods and services.

When card 5 is presented as payment for goods and services, the computer program product first causes processor 50 to determine in step 105 if the goods and services sought are third party administrator benefit 55 plan approved goods and services. The third party administrator benefit 55 plan may be an FSA, DFSA, HRA, QTBRA, HSA, or other types of federal approved accounts under the Internal Revenue Code.

If the goods and services sought are third party administrator benefit 55 plan approved goods and services, then the computer program product causes processor 50 to determine in step 110 if sufficient funds are available in the restricted account fund bucket. If sufficient funds are available in the second restricted account, in step 115 the computer program product causes processor 50 to deduct the cost of the goods and services from the amount of funds in the restricted account fund bucket. If sufficient funds are not available in the restricted account fund bucket, in step 120 the computer program product causes processor 50 to determine if partial funds are available in the restricted account fund bucket to cover a portion of the costs of the purchase of the third party administrator benefit 55 plan approved goods and services. If partial funds are available in the restricted account fund bucket, the computer program product causes processor 50 to then determine in step 135 if sufficient funds are available in the unrestricted account fund bucket for the balance of the cost of third party administrator benefit 55 plan approved goods and services. If sufficient funds are available in the unrestricted account fund bucket to cover the balance of the cost of third party administrator benefit 55 plan approved goods and services, in step 140 the computer program product causes processor 50 to first deduct the partial amount of funds from the restricted account fund bucket, and then deducts the balance of the cost of the third party administrator approved benefit 55 plan goods and services from the funds in the unrestricted account fund bucket.

If the goods and services sought to be purchased are not third party administrator benefit 55 plan approved goods and services, in step 130 the computer program product causes processor 50 to determine if sufficient funds are available in the unrestricted account fund bucket. If sufficient funds are available in the unrestricted account fund bucket for the cost of the goods and services sought, in step 150 the computer program product causes processor 50 to deduct the cost from the amount of funds in the unrestricted account fund bucket.

If sufficient funds are not available in the restricted account fund bucket nor the unrestricted account fund bucket, then the computer program product causes processor 50 to deny approval of the requested purchase of goods and services in steps 145 and 155.

The different fund buckets can have different limitations placed on the account fund buckets that limit the rate at which funds can be spent from a given fund bucket. These limitations can be different for different cards 5 processed using this computer program.

The computer program product may also cause processor 50 to use other account fund buckets including for example an overdraft protection fund bucket that allows a card used in the system to exceed the amount of funds available in the restricted and unrestricted fund buckets discussed above.

The computer program may also cause processor 50 to access information associated with an account such as insurance that may be available, e.g., health insurance. When the card is presented as payment for goods and services, such as a doctor's office, the computer program interacts with an insurance provider 90 to determine the amount of payment owed by the account based on the insurance policy information associated with the financial card. The computer program then determines if funds are available and from which account to deduct funds, and communicate any necessary information to the insurance provider 90 and/or goods and services provider.

The invention further relates to card 5 that has electronically accessible indicia 15 thereon defining a card account number, and containing at least a first and second data storage areas containing electronically accessible data therein for storing electronically retrievable data regarding a first and a second account fund buckets. Card 5 has a first data storage area for data regarding account fund bucket having funds available for unrestricted purchase of goods and services. Card 5 has a second account fund bucket having funds available for restricted purchases of goods and services for third party administrator benefit 55 plan approved goods and services. Card 5 may have additional data storage areas for similar storage of electronically retrievable data regarding additional restricted or unrestricted account fund buckets.

The different fund buckets represented in the data storage areas of card 5 can have different limitations placed on the account fund buckets that limit the rate at which funds can be spent from a given fund bucket. Furthermore, these limitations can be different for different cards 5.

Card 5 may access a financial network through a POS device 40, an Internet website 75, or a telephone call center 85. The financial network 45 accessed by card 5 may be a credit card network, regional debit network, or other network used to transmit financial data for the routing of transaction information. If a credit card network is used, card 5 may bear the financial network logo 30 of the credit network being used, such as the examples listed above. Similarly, if a regional debit network is used card 5 may bear the financial network logo 30 of one or more regional debit networks, such as the examples listed above. Additionally, card 5 may bear a sponsor logo 25 or identify a pharmacy benefit member, a corporate sponsor, or an employer of the cardholder.

Card 5 may also have data thereon allowing use or access of other account fund buckets including for example an overdraft protection fund bucket that allows card 5 to exceed the amount of funds available in the restricted and unrestricted fund buckets discussed above.

Card 5 may also be used access or provide information associated with an account such as insurance that may be available, e.g., health insurance, for an insurance provider 90.

Having described the invention above, various modifications of the techniques, procedures, components and equipment will be apparent to those skilled in the art. It is intended that all such variations within the scope and spirit of the appended claims be embraced thereby.

What is claimed is:

1. A method of processing transactions in response to a financial card presented as payment of a purchase of goods and services, comprising the steps of:
determining if the purchase of goods and services is a purchase of third party administrator benefit plan approved goods and services,
determining if sufficient funds are available in a restricted account fund bucket with an amount of restricted funds for the purchase of third party administrator benefit plan approved goods and services to cover a cost of the purchase of third party administrator benefit plan approved goods and services,
deducting the cost of the purchase of third party administrator benefit plan approved goods and services from the restricted funds in the restricted account fund bucket,
determining if partial funds are available in the restricted account fund bucket for the cost of purchase of third party administrator benefit plan approved goods and services,
determining if funds are available in an unrestricted account fund bucket with an amount of unrestricted funds for a balance of the cost of the purchase of third party administrator benefit plan approved goods and services,
deducting the partial amount of funds from the restricted account fund bucket,
deducting the balance of the cost of the purchase from the unrestricted account fund bucket,
determining if funds are available in the unrestricted account fund bucket for a purchase of goods and services that are not approved third party administrator benefit plan,
deducting the amount of funds from the first unrestricted account fund bucket for the purchase of goods and services that are not approved third party administrator benefit plan,
denying approval of a requested purchase of goods and services if funds are not available.

2. The method of claim 1, further comprising the step of determining if the purchase of goods and services is the purchase of third party administrator benefit plan approved goods and services depending on a merchant category code.

3. The method of claim 1, where the restricted account fund bucket is a type of federally approved benefit account under the Internal Revenue Code.

4. The method of claim 1, further comprising the steps of:
determining if sufficient anticipated restricted funds will be available at a future date in the restricted account fund bucket depending on anticipated deposits to the restricted account fund bucket; and
deducting the cost of the purchase of third party administrator benefit plan approved goods and services from the anticipated restricted funds in the restricted account fund bucket.

5. The method of claim 1, further comprising the step of determining if the unrestricted account fund bucket has over draft protection to allow for the purchase of goods and services if sufficient funds are not available at the time of the purchase.

6. The method of claim 1, further comprising the steps of:
determining if the financial card presented as payment of the purchase of goods and services has an associated insurance policy;
determining if the purchase of goods and services are covered benefits of the insurance policy;
determining the cost of the purchase of goods and services, if the purchase of goods and services are covered benefits of the insurance policy; and
determining if the purchase of goods and services that are covered benefits of the insurance policy are the purchase of third party administrator benefit plan approved goods and services.

7. A financial card system in response to processing transactions for a financial card presented for payment, the financial card system comprising a:
a card processor connected to a card reader through a financial network for receiving and processing data relating to a transaction for the financial card presented for payment,
the card processor performing the steps of:
determining if the purchase of goods and services is a purchase of third party administrator benefit plan approved goods and services,
determining if sufficient funds are available in a restricted account fund bucket with an amount of restricted funds for the purchase of third party administrator benefit plan approved goods and services to cover a cost of the purchase of third party administrator benefit plan approved goods and services,
deducting the cost of the purchase of third party administrator benefit plan approved goods and services from the restricted funds in the restricted account fund bucket,
determining if partial funds are available in the restricted account fund bucket for the cost of purchase of third party administrator benefit plan approved goods and services,
determining if funds are available in an unrestricted account fund bucket with an amount of unrestricted funds for a balance of the cost of the purchase of third party administrator benefit plan approved goods and services,
deducting the partial amount of funds from the restricted account fund bucket,
deducting the balance of the cost of the purchase from the unrestricted account fund bucket,
determining if funds are available in the unrestricted account fund bucket for a purchase of goods and services that are not approved third party administrator benefit plan,
deducting the amount of funds from the first unrestricted account fund bucket for the purchase of goods and services that are not approved third party administrator benefit plan,
denying approval of a requested purchase of goods and services if funds are not available.

8. The financial card system of claim 7, further comprising the card processor performing the step of determining if the purchase of goods and services is the purchase of third party administrator benefit plan approved goods and services depending on a merchant category code.

9. The financial card system of claim 7, where the restricted account fund bucket is a type of federally approved account under the Internal Revenue Code.

10. The financial card system of claim 7, further comprising the card processor performing the steps of:
determining if sufficient anticipated restricted funds will be available in the restricted account fund bucket depending on anticipated deposits to the restricted account fund bucket; and
deducting the cost of the purchase of third party administrator benefit plan approved goods and services from the anticipated restricted funds in the restricted account fund bucket.

11. The financial card system of claim 7, further comprising the card processor performing the step of determining if the unrestricted account fund bucket has over draft protection to allow for purchase of goods or services if sufficient funds are not available at the time of purchase.

12. The financial card system of claim 7, further comprising the card processor performing the steps of:
determining if the financial card presented as payment of the purchase of goods and services has an associated insurance policy;
determining if the purchase of goods and services are covered benefits of the insurance policy;
determining the cost of the purchase of goods and services, if the purchase of goods and services are covered benefits of the insurance policy; and
determining if the purchase of goods and services that are covered benefits of the insurance policy are the purchase of third party administrator benefit plan approved goods and services.

13. A computer program product stored in signal bearing media for causing a computer processor to process transactions in response to a financial card presented for payment of a purchase of goods and services, the computer program product containing instructions stored in machine-readable code and causing the computer processor to perform the following steps:
determining if the purchase goods and services is a purchase of third party administrator benefit plan approved goods and services,
determining if sufficient funds are available in a restricted account fund bucket for the purchase of third party administrator benefit plan approved goods and services,
deducting a cost of purchase of third party administrator benefit plan approved goods and services from the funds in the restricted account fund bucket,
determining if partial funds are available in the second restricted account fund bucket for the purchase of third party administrator benefit plan approved goods and services,
determining if sufficient funds are available in the first unrestricted account fund bucket for a balance of the cost of third party administrator benefit plan approved goods and services,
deducting the partial amount of funds from the second restricted account fund bucket,
deducting the balance of the cost of funds from the first unrestricted account fund bucket,
determining if sufficient funds are available in the first unrestricted account fund bucket,
deducting the amount of funds from the first unrestricted account fund bucket,
denying approval of the requested purchase of goods and services if funds are not available.

14. The computer program product of claim 13, the computer program product containing further instructions stored in machine-readable code and causing the computer processor to perform the step determining if the purchase of goods and services is the purchase of third party administrator benefit plan approved goods and services depending on a merchant category code.

15. The computer program product of claim 13, where the restricted account fund bucket is a type of federally approved account under the Internal Revenue Code.

16. The computer program product of claim 13, the computer program product containing further instructions stored in machine-readable code and causing the computer processor to perform the following steps:
determining if sufficient anticipated restricted funds will be available in the restricted account fund bucket depending on anticipated deposits to the restricted account fund bucket; and
deducting the cost of the purchase of third party administrator benefit plan approved goods and services from the anticipated restricted funds in the restricted account fund bucket.

17. The computer program product of claim 13, the computer program product containing further instructions stored in machine-readable code and causing the computer processor to perform the step of determining if the unrestricted account fund bucket has over draft protection to allow for purchases if sufficient funds are not available at the time of purchase.

18. The computer program product of claim 13, the computer program product containing further instructions stored in machine-readable code and causing the computer processor to perform the steps of:
determining if the financial card presented as payment of the purchase of goods and services has an associated insurance policy;
determining if the purchase of goods and services are covered benefits of the insurance policy;
determining the cost of the purchase of goods and services, if the purchase of goods and services are covered benefits of the insurance policy; and
determining if the purchase of goods and services that are covered benefits of the insurance policy are the purchase of third party administrator benefit plan approved goods and services.

19. A financial card comprising:
a card with indicia thereon defining a card account number,
the card having data storage areas thereon for storing electronic data regarding a first and a second associated account fund buckets,
the first account fund bucket data storage area storing data regarding funds available for unrestricted purchase of goods and services,
the second account fund bucket data storage area storing data regarding having funds available for restricted purchases of goods and services for third party administrator benefit plan approved goods and services.

20. The financial card of claim 19, further comprising the second account fund bucket that is a type of federally approved account under the Internal Revenue Code.

21. The financial card of claim 19, further comprising the first account fund bucket having over draft protection to allow for the purchase of goods and services if sufficient funds are not available at the time of purchase.
